(19) United States
(12) Patent Application Publication
(10) Pub. No.: US 2011/0075514 A1
(43) Pub. Date: Mar. 31, 2011

(54) APPARATUS AND METHODS FOR ATTENUATING SEISMIC NOISE ASSOCIATED WITH ATMOSPHERIC PRESSURE FLUCTUATIONS

(75) Inventors: César Barajas-Olalde, Tampico (MX); Wail A. Mousa, Makkak (SA); Amine Ennaifer, Ariana Superieure (TN); Patrice Ligneul, Al-Khobar (SA)

(73) Assignee: SCHLUMBERGER TECHNOLOGY CORPORATION, Cambridge, MA (US)

(21) Appl. No.: 12/569,038

(22) Filed: Sep. 29, 2009

(51) Int. Cl. G01V 1/36

(52) U.S. Cl. 367/43

(57) ABSTRACT

Apparatus and methods are described for attenuating noise associated with atmospheric pressure fluctuations in a seismic signal during seismic data acquisition using at least a pair of sensors comprising a seismic sensor and a pressure sensor for concurrently receiving a seismic signal and a pressure signal respectively, the sensors being adapted individually to transmit the respective seismic and pressure signals to a remote recording station which is adapted to record a plurality of seismic and pressure signals; and a filter for removing, at least partly, noise associated with atmospheric pressure fluctuations in the seismic signal, the filter employing an input signal from the pressure sensor; and a model of the coupling between the atmosphere and the ground to generate a reference signal which is combined with the seismic signal to produce an output signal.

### FIELD OF THE INVENTION

This invention relates to apparatus and methods for attenuating noise associated with atmospheric pressure fluctuations in a seismic signal acquired during land seismic data acquisition operations.

### BACKGROUND TO THE INVENTION

Wind is considered to be one of the most common sources of noise in acquired seismic signals. Wind noise generally appears in a seismic signal when there is a significant amount of wind (surface pressure fluctuation or atmospheric events) on the surface above the seismic sensors during seismic data acquisition. Wind on the surface causes wind-ground coupled seismic waves under the surface which are recorded by the seismic sensors as noise, which in turn can lead to considerable degradation of the quality of the data.

Generally speaking, noise due to atmospheric events can be attributed to two distinct phenomena, namely acoustic waves generated by a point source (for example sound waves generated by noisy machinery) and fluctuating atmospheric pressure associated with a convection phenomenon (wind). The present invention is concerned mainly with the attenuation of noise associated with fluctuating atmospheric pressure using dual sensors (seismic- and pressure sensors).

The combination of geophones and microphones to record seismic noise for the attenuation of air-coupled waves has been reported in the literature (for example in Bass, H. E., and Bolen, L. N., Cress, D., Lundien, J., Flohr, M., 1980, Coupling of airborne sound into the earth: Frequency dependence, J. Acoust. Soc. Am., 67(5), 1502-1506; Sabatier, J. M., Bass, H. E., Bolen, L. N., and Attenborough, K., 1986a, Acoustically induced seismic waves, J. Acoust. Soc. Am., 80(2), 646-649; and Sabatier, J. M., Bass, H. E., and Elliot, G. R., 1986b, On the location of frequencies of maximum acoustic-to-seismic coupling, J. Acoust. Soc. Am., 80(4), 1200-1202). However, these works are confined mainly to the measurement of an acoustic-to-seismic transfer function.

The patents of Cowles, C. S., 1979, Combination Geophone-Hydrophone, U.S. Pat. No. 4,134,097 A1 and Brittan, J., and Starr, J. G., 2004, Method for Processing Dual Sensor Seismic Data to Attenuate Noise, U.S. Pat. No. 6,894,948 are further examples in the literature of descriptions of the use of dual sensors. These works refer to geophone-hydrophone combinations to remove noise of borehole and marine seismic data respectively and do not address the attenuation of wind noise.

The patent of Crews, G. A. and Martinez, D. R., Seismic Exploration Method and Apparatus for Cancelling Non-Uniformly Distributed Noise, U.S. Pat. No. 4,890,264 mentions that microphones can be used to detect and effectively cancel the non-uniformly distributed effects (non-coherent) of wind noise without providing any detailed description. For example, the disclosure deals with wind noise which “adversely affects the recording of seismic waves by moving cables or geophones . . . ” at Column 4, line 64.

It is accordingly an object of the present invention to provide improved apparatus and methods for attenuating noise associated with atmospheric pressure fluctuations in recorded seismic signals during single sensor seismic data acquisition operations. The invention also addresses the broader problem of attenuating noise recorded in seismic signals during seismic data acquisition operations and specifically deals with the attenuation of coherent noise caused by fluctuating pressure in the atmosphere above a seismic data acquisition array.

### SUMMARY OF THE INVENTION

Accordingly, it is a first aspect of the invention to provide apparatus for attenuating noise associated with atmospheric pressure fluctuations in a seismic signal during seismic data acquisition, including:

at least a pair of sensors comprising a seismic sensor and a pressure sensor for concurrently receiving a seismic signal and a pressure signal respectively, the sensors being adapted individually to transmit the respective seismic and pressure signals to a remote recording station which is adapted to record a plurality of seismic and pressure signals; and
data processing means including filter means for removing, at least partly, noise associated with atmospheric pressure fluctuations in the seismic signal, wherein the filter means employs an input signal from the pressure sensor; and a model of the coupling between the atmosphere and the ground to generate a reference signal which is combined with the seismic signal to produce an output signal.

The model of the coupling between the atmosphere and the ground is preferably used to predict the type of signals which may be generated by the pressure fluctuations. With this knowledge, it is possible to predict the type of seismic waves generated (phase and amplitude of the seismic signals) and to have a better spatial sampling of the signals (distribution of the geophones on the ground).

In a preferred form of the invention, the pressure sensor comprises a microphone, more preferably a MEMS microphone.

The data processing means may include additional filter means in the form of a noise cancellation filter for removing noise in the seismic- and pressure signals that are not related to atmospheric pressure fluctuations. In a preferred form of the invention the noise cancellation filter comprises an adaptive Recursive Least Squares noise cancellation filter.

The Recursive Least Squares (RLS) noise cancellation filter is used to attenuate non-coherent atmospheric noise in the proximity of the data acquisition operations, such as noise generated by machinery and workers generally. This type of noise would mainly be in the form of point source acoustic events.

In a preferred form of the invention, the data processing means includes scaling means for rescaling at least one of the seismic- and pressure signals.

The seismic signal would normally be scaled to match the pressure signal before the signals are combined

In this specification and in the appended claims, the terms “combine” or “combined” mean, insofar as they relate to seismic, pressure or reference signals, either “added to” or “subtracted from” depending on the phase shift of the signals which are combined. For example, where the phase shift between the seismic signal and the pressure signal is zero, the pressure signal is subtracted from the seismic signal to produce an attenuated output signal. Where there is a 90 degree phase shift between the signals, the pressure signal is added to the seismic signal to produce an attenuated output signal.

Optionally, the data processing means may include a band pass filter for passing the seismic signal and the pressure signal there-through to establish a common minimum and maximum frequency band for both sensors.

It is a second aspect of the invention to provide a method of real-time processing of seismic data during single sensor seismic data acquisition operations comprising the steps of:

receiving, at a remote recording station, a seismic signal transmitted by a seismic sensor and receiving a pressure signal concurrently transmitted by a pressure sensor;
employing an input signal from the pressure sensor and a model of the coupling between the atmosphere and the ground to generate a reference signal; and combining the reference signal with the seismic signal to produce an output signal.

The method may include the step of passing both the seismic signal and the pressure signal through a noise cancellation filter after receipt at the remote recording station in order to remove noise in at least one of the seismic- and pressure signals which is not related to atmospheric pressure fluctuations.

The method may include the further step of passing the seismic signal and the pressure signal through a band pass filter to establish a common minimum and maximum frequency band for the signals.

The method may include the further step of rescaling at least one of the seismic signal and pressure signal after removal of noise by the noise cancellation filter.

It is a third aspect of the invention to provide a method of off-line processing of seismic data recorded during single sensor seismic data acquisition operations comprising the steps of:

receiving, at a remote recording station, a seismic signal transmitted by a seismic sensor buried in ground and receiving a pressure signal concurrently transmitted by a pressure sensor located above the ground;
selecting a time band from the recorded signals;
transforming the signal data from the seismic signal and the pressure signal in the selected time band from the time domain to the time-frequency domain;
applying adaptive filtering in the time-frequency domain to remove non-coherent noise in the signals;
deriving ratios of ground particle velocity over atmospheric pressure to obtain the inverse of the acoustic impedance of the ground;
deriving a time transfer function of the ground by applying the inverse of a transform operation to the inverse of the acoustic impedance of the ground;
estimating a particle velocity in the atmosphere by convoluting the transfer function; and
subtracting the particle velocity component of the seismic signal from the seismic signal to produce an output signal.

In a preferred form of the invention, the transform operation is the Stockwell Transform.

It is a fourth aspect of the invention to provide a method of off-line processing of seismic data during single sensor seismic data acquisition operations comprising the steps of:

receiving, at a remote recording station, a seismic signal transmitted by a seismic sensor and receiving a pressure signal concurrently transmitted by a pressure sensor;
passing the seismic signal through a filter bank wherein it is decomposed into M-bands;
selecting bands for processing;
reconstructing a seismic signal from the selected bands;
normalizing the reconstructed seismic signal and the pressure signal;
applying a Recursive Least Squares algorithm to at least one of the signals to remove non-coherent noise; and
combining the signals to produce an output signal.

The bands are preferably decimated after filtering and over-sampled and interpolated before reconstruction.

It is a fifth aspect of the invention to provide a seismic data recording array for comprising:

a plurality of seismic sensors linearly disposed and buried in the ground;
a plurality of pressure sensors interspersed between and exposed to the atmosphere above the seismic sensors: and
a remote recording station;
the seismic sensors and the pressure sensors being adapted individually to transmit the respective seismic- and pressure signals to the remote recording station:
characterised in that the distance between successive pressure sensors is substantially equal to an estimated wavelength of a pressure fluctuation waveform.

The seismic data recording array may be further characterised in that the distance between successive seismic sensors is substantially half the estimated wavelength of the pressure fluctuation waveform.

### BRIEF DESCRIPTION OF THE DRAWINGS

The above and further aspects of this invention will now be described in more detail with reference to the following drawings, in which:

FIG. 1 is a schematic representation of a dual sensor pair according to the invention, located in a position suitable for seismic data acquisition;

FIG. 2 is a flow diagram of a method of real time data processing of seismic and pressure data according to the invention;

FIG. 3 is a flow diagram of a first method of off-line data processing of seismic and pressure data according to the invention;

FIG. 4 is a flow diagram of a second method of off-line data processing of seismic and pressure data according to the invention;

FIG. 5 shows the phase shift between a seismic signal and a concurrently transmitted pressure signal during seismic data acquisition operations;

FIG. 6 shows graphic examples illustrating the attenuation of noise associated with atmospheric pressure fluctuations during the seismic data acquisition;

FIG. 7 shows graphic examples of autocorrelation of a pressure signal and seismic signals and cross correlation of the pressure and seismic signals during methods of data processing according to the invention; and

FIG. 8 is a plan view schematic representation of one embodiment of the layout of a seismic data recording array according to the invention.

### DETAILED DESCRIPTION

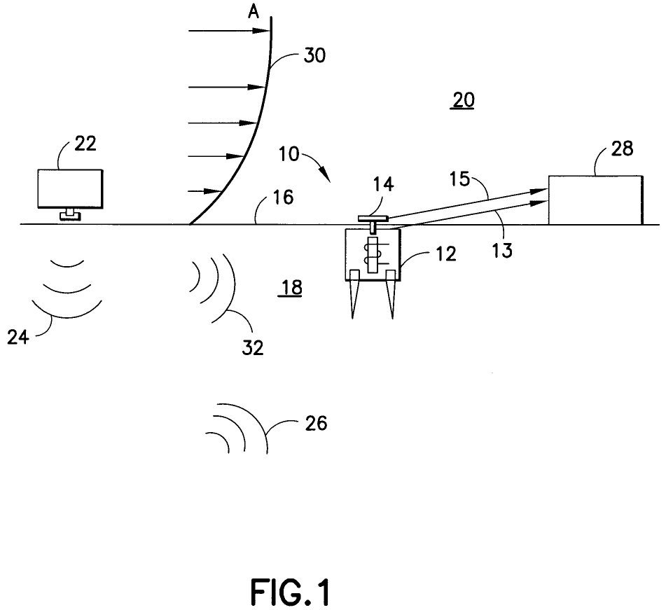

In FIG. 1, apparatus 10 according to an example of the invention shows a seismic sensor in the form of a geophone 12 and a pressure sensor in the form of a Micro Electrical-Mechanical System (MEMS) microphone 14. The geophone 12 is buried beneath the surface 16 of the ground 18 and the microphone 14 is exposed to the atmosphere 20 above the surface 16 of the ground 18.

During seismic data acquisition operations, a seismic source, such as a seismic vibrator 22 is energised which excites a series of seismic waves in a specific pattern and frequency range (sweep) 24. Return waves 26 are reflected from geological formations (not shown) underground and are received by the geophone 12.

The geophone 12, which forms part of a recording array (not shown in this drawing), responds to the seismic waves 26 and produces a corresponding seismic signal 13. Each geophone 12 in the array then individually transmits the signal 13 to a remote data recording station 28.

FIG. 1 further shows an atmospheric pressure wave 30 travelling in direction A towards apparatus 10. The pressure wave 30 produces a ground coupled seismic wave 32 under the surface 16 of the ground 18, which is received by the geophone 12. Thus, the seismic signal 13 transmitted to the remote data recording station 28 includes the signal representative of the reflected seismic wave 26 as well as the signal representative of the ground coupled wave 32, which is regarded as noise which degrades the signal 13.

The pressure wave 30 represents pressure fluctuations or wind in the atmosphere 20 above the apparatus 10. These pressure fluctuations are traced by the microphone 14 which transmits a pressure signal 15 concurrently with the transmission of the seismic signal 13, to the remote recording station 28. The pressure signal 15 is representative of the ground coupled seismic signal 32, (noise) and is used to attenuate the noise from the seismic signal 13 as is described hereunder.

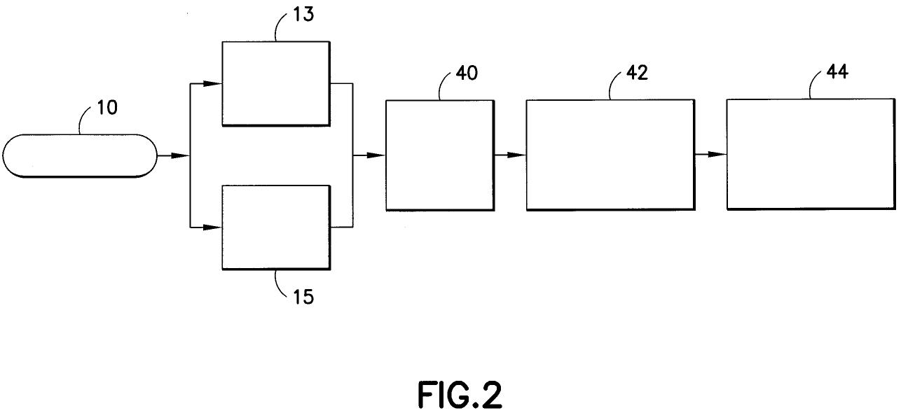

FIG. 2 illustrates how real-time processing of the seismic and pressure signals 13, 15 respectively of FIG. 1 is executed.

Apparatus 10 produces a seismic signal 13 and a pressure signal 15 as described with reference to FIG. 1. At 40, both the seismic signal 13 and the pressure signal 15 are passed through an adaptive Recursive Least-Squares (RLS) noise cancellation filter in order to remove noise not related to atmospheric pressure fluctuations. The processed signals 13, 15 are then passed through a band pass filter to establish the same minimum and maximum frequency band for both signals. This step is optional and will depend on the specifications of the sensors 12, 14 and the data acquisition parameters selected. Due to a difference in scale of the signals 13, 15, a scale factor is used to rescale the seismic signal 13 to match the pressure signal 15. These operations are executed at 40. From a theoretical model, it is possible to estimate the amplitude of the seismic signal 13 and the scaling factor is determined from the estimated amplitude of the seismic signal and the maximum value of the pressure signal 15. It is also possible simply to apply an ad hoc approach by using the wind speed measured during the recording to scale the seismic signal 13. Applicant has found that both methods can be satisfactorily applied but in real time processing, the approach based on the theoretical model is recommended.

The output of 40 produces an equivalent seismic signal and pressure signal at 42.

The final step is to use the output pressure signal of step 42 and to combine it with the output seismic signal to remove the noise due to atmospheric pressure fluctuations from the seismic signal and to produce an attenuated seismic signal at 44.

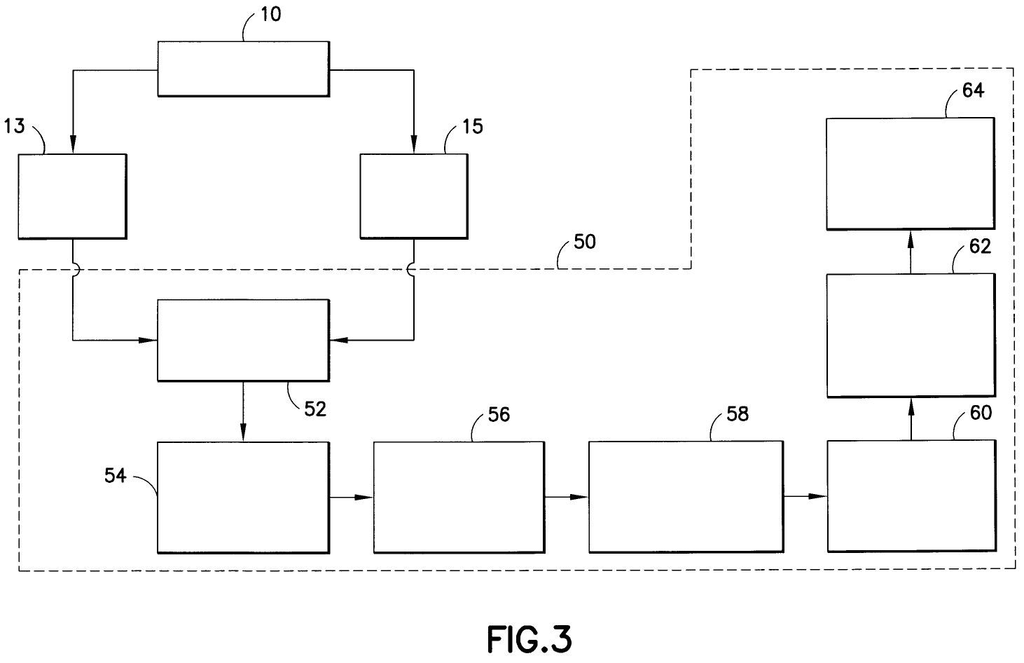

FIG. 3 is a flow diagram of a first method of off-line data processing of seismic and pressure data according to the invention. This method is used when the interaction of the pressure fluctuations with the ground manifests itself in the form of coherent events in the signals of the sensors 12, 14.

In this drawing, the apparatus 10 is shown to transmit the seismic signal 13 and the pressure signal 15 to a remote recording station 50 (see dotted line).

At the recording station 50, an appropriate time band of both signals is selected at 52 for further processing. The data from both the seismic signal 13 and the pressure signal 15 is then transformed, using the S-transform, from the time domain into the time-frequency domain at 54. This step is completed in preparation for the next step, which is adaptive filtering of non-coherent noise in both the seismic signal 13 and the pressure signal 15 at 56. Applicant has found that adaptive filtering of the non-coherent noise can be more conveniently done in the time-frequency domain than the time domain. After adaptive filtering, ratios of ground particle velocity over atmospheric pressure are derived at 58 to obtain the inverse of the acoustic impedance of the ground. A time transfer function of the ground is derived by applying the inverse of the Stockwell Transform to the inverse of the acoustic impedance of the ground at 60. Thereafter, a particle velocity in the atmosphere is estimated by convoluting the transfer function at 62. Finally, by subtracting the particle velocity component of the seismic signal from the seismic signal at 64, an attenuated output signal is produced.

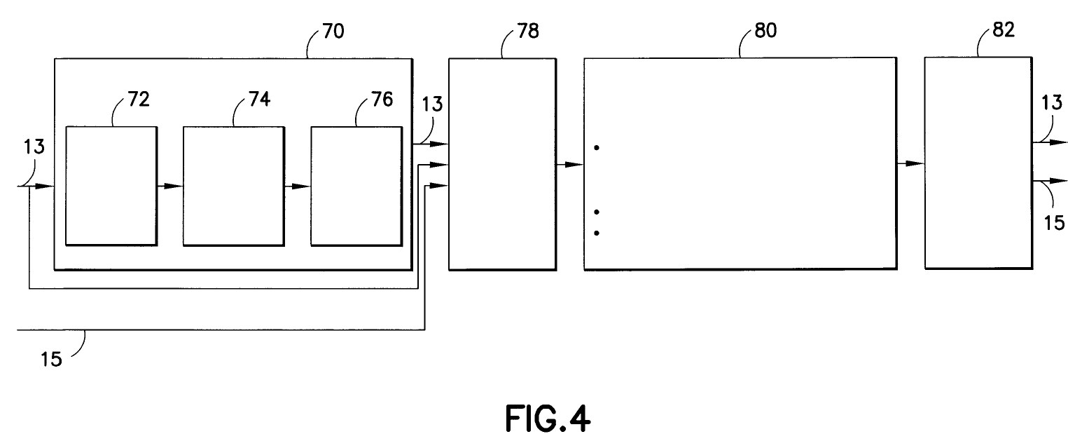

FIG. 4 is a flow diagram of a second method of off-line data processing of seismic and pressure data according to the invention. This method is used where the pressure fluctuation signals are random events. Applicant has found that in this case, the use of a filter bank system is the most effective.

In this drawing, the seismic signal 13 is shown to be passed through a filter bank 70, where the signal 13 is decomposed into M-bands by way of a set of low-pass, band-pass and high-pass filters 72. For a more detailed description of this known method for noise attenuation reference can be made to Ozbek, Ali, Adaptive Seismic Noise and Interference Attenuation Method, U.S. Pat. No. 6,446,008 B1 and Ozbek, Ali, Noise Filtering Method for Seismic Data, International Publication No. WO 97/25632, 17 Jul. 1997. The object of this known method is to identify (or estimate) the coherent noise in the signal, which is removed in the next step at 80. Essentially, an extraction of spectral components of the signal 13 is effected to produce multiple output signals from the original signal. To mitigate complexity, each output signal is decimated. At this stage, the appropriate parts (bands) of the original seismic signal 13 are selected to be further processed by way of a soft threshold process at 74. Each signal band signal is then over sampled and passed through an interpolation filter. An output signal is then reconstructed from the selected bands at 76.

The reconstructed seismic signal 13 and the pressure signal 15 are then normalised at 78. The signals are then filtered in three iterations. In the first iteration, coherent noise in the seismic signal 13 is attenuated when signals are passed through a Recursive Least Squares noise cancellation filter 80. In a second iteration, electromagnetic noise in both the seismic and pressure signals is attenuated. Ambient noise is removed in a third iteration. The data is then denormalised at 82 to produce a filtered seismic signal 13 and a filtered pressure signal 15. The output of this step can be used to remove pressure fluctuation noise from the seismic signal 13 having, as a reference, the pressure signal 15 data.

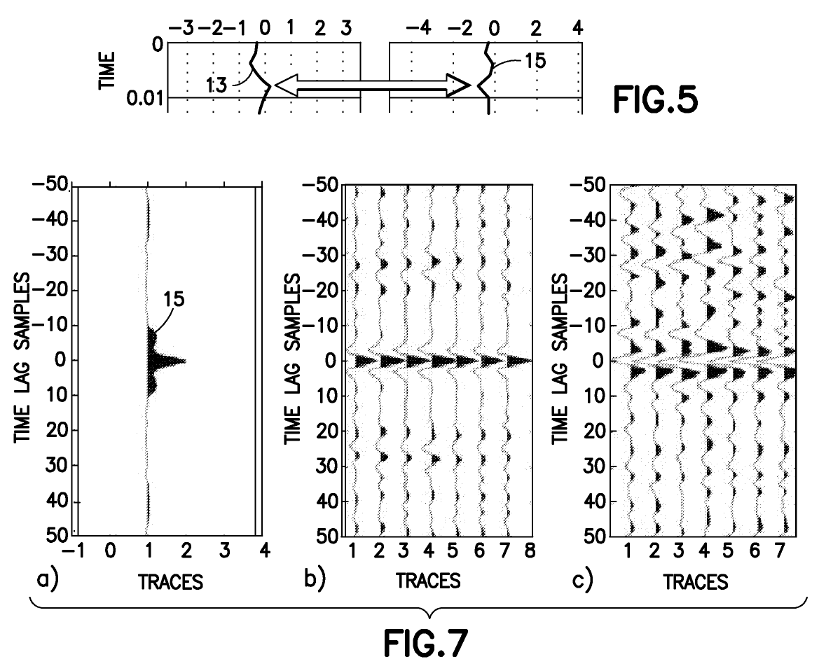

In FIG. 5 the phase shift between a seismic signal 13 and a concurrently transmitted pressure signal 15 is shown the instant that the components of the dual sensor (seismic- and pressure-sensors) detect pressure fluctuations in the form of wind noise signals. Experiments by the Applicant predict an out of phase relationship between pressure and particle velocity. This allows a simple “subtraction” of the pressure signal from the seismic signal 13 to cancel the effect of pressure fluctuation in the seismic signal 13.

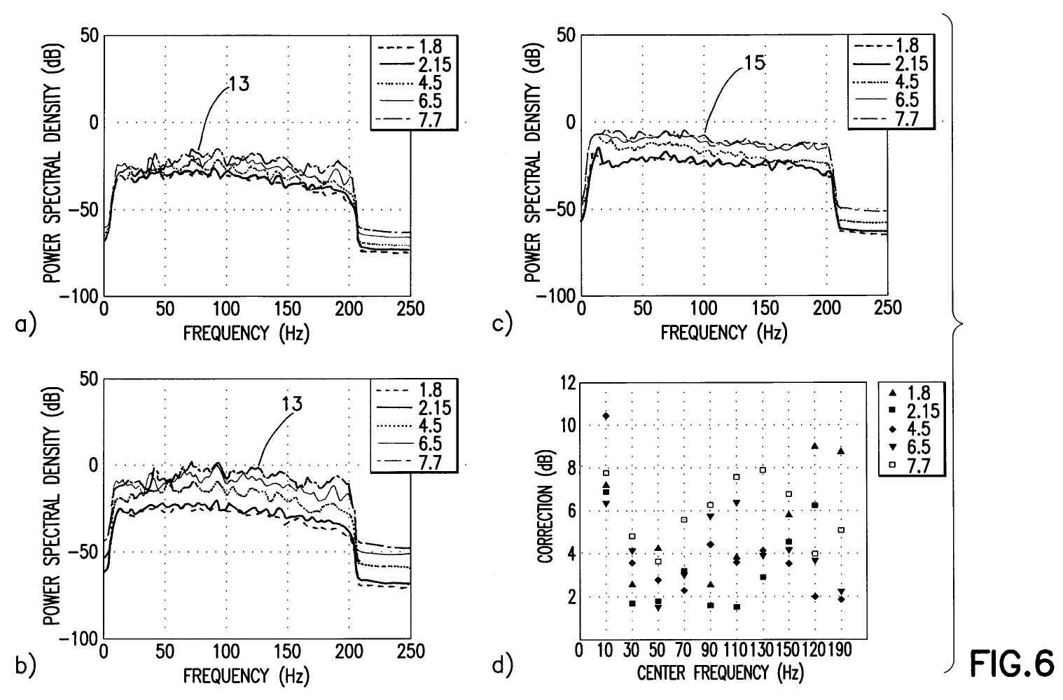

In FIG. 6, graphic examples 6A to 6d illustrate the attenuation of noise associated with atmospheric pressure fluctuations during seismic data acquisition. In particular, FIG. 6a shows a power spectrum of the seismic signal 13 after having passed through the RLS noise cancellation filter. FIG. 6b shows the power spectrum of the seismic signal of FIG. 6a appropriately scaled. FIG. 6c shows the power spectrum of the pressure signal 15 after RLS noise cancellation and after it passed through a band pass filter. FIG. 6d shows the attenuation of pressure fluctuation noise on the seismic signal 13 given in dB for different center frequencies and wind speeds.

In FIG. 7, graphic examples of autocorrelation of a pressure signal and seismic signals and cross correlation of the pressure and seismic signals during methods of data processing according to the invention are shown.

In particular, FIG. 7a shows the autocorrelation of the pressure signal 15. FIG. 7b shows the autocorrelation of seven individually recorded seismic signals, one of them being the seismic signal 13 from the geophone 12 of FIG. 1 and the other six from geophones in the proximity of geophone 12. FIG. 7c shows the cross-correlation of the pressure signal 13 and seven seismic signals. In this drawing, a good correlation at zero time lag can be observed. It shows that both sensors 12 and 14 of FIG. 1 are recording a similar event that can be attributed to wind noise (no seismic source was used in this instance). Some noise can be observed at lags other than zero.

It will be appreciated that in FIG. 7c, it is shown that the polarity of the cross-correlation is reversed when compared to FIGS. 7a and 7b. This is because the pressure-time series has the opposite amplitude to the particle velocity (seismic) time series as is also observed in FIG. 5 above.

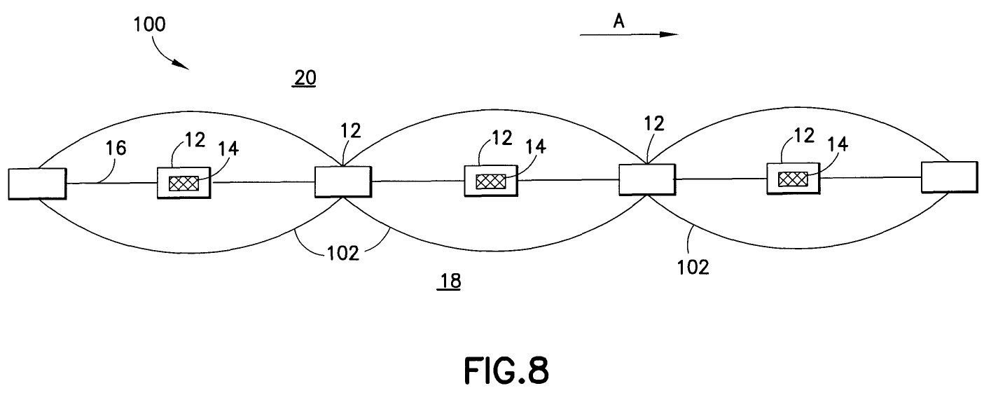

FIG. 8 shows the preferred layout of a seismic data recording array 100 in plan view. Geophones 12 are linearly disposed and buried in the ground in the prevailing wind direction A. Interspersed between the geophones 12 are a plurality of MEMS microphones 14, exposed to the atmosphere 20 above the geophones 12 as shown. In this embodiment, a microphone 14 is paired with every second geophone 12.

The geophones 12 and microphones 14 are spaced such that the distance between two successive geophones 12 is about half the wavelength of an estimated pressure fluctuation waveform 102. In the present instance, the wavelength of the pressure fluctuation waveform is about 10 meters, an accordingly, the geophones 12 are spaced by 5 meters and the microphones 14 by 10 meters. The remote recording station is not shown in this drawing.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative processes, one skilled in the art will recognize that the system may be embodied using a variety of specific procedures and equipment and could be performed to evaluate widely different types of applications. Accordingly, the invention should not be viewed as limited except by the scope of the appended claims

What is claimed is:

1. Apparatus for attenuating noise associated with atmospheric pressure fluctuations in a seismic signal during seismic data acquisition, including:
at least a pair of sensors comprising a seismic sensor and a pressure sensor for concurrently receiving a seismic signal and a pressure signal respectively, the sensors being adapted individually to transmit the respective seismic- and pressure signals to a remote recording station which is adapted to record the signals of a plurality of seismic and pressure signals; and
data processing means including filter means for removing, at least partly, noise associated with atmospheric pressure fluctuations in the seismic signal, wherein the filter means employs an input signal from the pressure sensor; and a model of the coupling between the atmosphere and the ground to generate a reference signal which is combined with the seismic signal to produce an output signal.

2. Apparatus as claimed in claim 1 wherein the pressure sensor comprises a microphone.

3. Apparatus as claimed in claim 2 wherein the microphone comprises a MEMS microphone.

4. Apparatus as claimed in claim 1 wherein the data processing means includes additional filter means in the form of a noise cancellation filter for removing noise in at least one of the seismic- and pressure signals that is not related to atmospheric pressure fluctuations.

5. Apparatus as claimed in claim 4 wherein the noise cancellation filter is an adaptive Recursive Least Squares noise cancellation filter.

6. Apparatus as claimed in claim 1 wherein the data processing means includes scaling means for rescaling at least one of the seismic- and pressure signals.

7. Apparatus as claimed in claim 1 wherein the data processing means includes a band pass filter for passing the seismic signal and the pressure signal there-through to establish a common minimum and maximum frequency band for both sensors.

8. A method of real-time processing of seismic data during single sensor seismic data acquisition operations comprising the steps of:
receiving, at a remote recording station, a seismic signal transmitted by a seismic sensor and receiving a pressure signal concurrently transmitted by a pressure sensor;
employing an input signal from the pressure sensor and a model of the coupling between the atmosphere and the ground to generate a reference signal; and
combining the reference signal from the seismic signal to produce an output signal.

9. A method as claimed in claim 8 including the step of passing both the seismic signal and the pressure signal through a noise cancellation filter after receipt at the remote recording station in order to remove noise in at least one of the seismic- and pressure signals which is not related to atmospheric pressure fluctuations.

10. A method as claimed in claim 8 including the further step of passing the seismic signal and the pressure signal through a band pass filter to establish a common minimum and maximum frequency band for the signals.

11. A method as claimed in claim 8 including the further step of rescaling at least one of the seismic signal and the pressure signal after removal of noise by the noise cancellation filter.

12. A method of off-line processing of seismic data recorded during single sensor seismic data acquisition operations comprising the steps of:
receiving, at a remote recording station, a seismic signal transmitted by a seismic sensor buried in ground and receiving a pressure signal concurrently transmitted by a pressure sensor located above the ground;
selecting a time band from the recorded signals;
transforming the signal data from the seismic signal and the pressure signal in the selected time band from the time domain to the time-frequency domain;
applying adaptive filtering in the time-frequency domain to remove non-coherent noise in the signals;
deriving ratios of ground particle velocity over atmospheric pressure to obtain the inverse of the acoustic impedance of the ground;
deriving a time transfer function of the ground by applying the inverse of a transform operation to the inverse of the acoustic impedance of the ground;
estimating a particle velocity in the atmosphere by convoluting the transfer function; and
subtracting the particle velocity component of the seismic signal from the seismic signal to produce an output signal.

13. A method as claimed in claim 12 wherein the transform operation is the Stockwell Transform.

14. A method of off-line processing of seismic data during single sensor seismic data acquisition operations comprising the steps of:
receiving, at a remote recording station, a seismic signal transmitted by a seismic sensor and receiving a pressure signal concurrently transmitted by a pressure sensor;
passing the seismic signal through a filter bank wherein it is decomposed into M-bands;
selecting bands for processing;
reconstructing a seismic signal from the selected bands;
normalizing the reconstructed seismic signal and the pressure signal;
applying a Recursive Least Squares algorithm to at least one of the signals to remove non-coherent noise; and
combining the signals to produce an output signal.

15. A method as claimed in claim 14 wherein the bands are decimated after filtering and over-sampled and interpolated before reconstruction.

16. A seismic data recording array comprising:
a plurality of seismic sensors linearly disposed and buried in the ground;
a plurality of pressure sensors interspersed between and exposed to the atmosphere above the seismic sensors: and
a remote recording station;
the seismic sensors and the pressure sensors being adapted individually to transmit the respective seismic- and pressure signals to the remote recording station:
characterised therein that the distance between successive pressure sensors is substantially equal to an estimated wavelength of a pressure fluctuation waveform.

17. A seismic data recording array as claimed in claim 16 which is further characterised therein that the distance between successive seismic sensors is substantially half the estimated wavelength of the pressure fluctuation waveform.
